(19) United States
(12) Patent Application Publication
(10) Pub. No.: US 2012/0118184 A1
(43) Pub. Date: May 17, 2012

(54) FOIL TRANSFER DEVICE HAVING A VARIABLE GUIDE SYSTEM

(75) Inventors: JOACHIM SONNENSCHEIN, MUEHLTAL (DE); ALEXANDER WEBER, WEINHEIM (DE)

(73) Assignee: HEIDELBERGER DRUCKMASCHINEN AG, HEIDELBERG (DE)

(21) Appl. No.: 13/295,269

(22) Filed: Nov. 14, 2011

(30) Foreign Application Priority Data
Nov. 12, 2010 (DE) 10 2010 051 238.9

(51) Int. Cl. B41F 7/02

(52) U.S. Cl. 101/217

(57) ABSTRACT

A transfer device for transferring a transfer layer to a printing material includes a transfer module disposed above a basic module. A guide system provides a way of easily and safely moving the transfer module within the foil transfer device or to a further foil transfer device in the same pressroom. The guide system includes tracks that are connected to the transfer module through rollers of a guide frame.

### CROSS-REFERENCE TO RELATED APPLICATION

This application claims the priority, under 35 U.S.C. §119, of German Patent Application DE 10 2010 051 238.9, filed Nov. 12, 2010; the prior application is herewith incorporated by reference in its entirety.

### BACKGROUND OF THE INVENTION

### Field of the Invention

The present invention relates to a transfer device for transferring a transfer layer from a transfer foil to a printing material. The transfer device includes an application unit for applying a layer of glue to the printing material, at least one basic module having a transfer cylinder for forming a transfer nip with an impression cylinder, and a transfer module having at least one foil supply reel and/or foil collection reel and a transfer foil supplied by the foil supply reel and guided through the transfer nip together with the printing material to transfer the transfer layer to the printing material in those regions of the printing material to which glue has been applied.

The transfer device preferably relates to the process known as cold-foil stamping.

Cold-foil stamping refers to the process of transferring a transfer layer from a carrier layer to a printing material.

The carrier material is a carrier foil. A layer of varnish that is responsible, in particular, for the color of the transfer layer, is applied to the carrier foil. The layer of varnish is connected to an aluminum layer that creates the glossy metallic effect of the transfer layer. In addition, an adhesive layer for improving the adhesion properties of the transfer layer with respect to the glue on the printing material may be provided on the aluminum layer. The layers that are transferred from the carrier material are referred to as the transfer layer.

In order to transfer the transfer layer to a printing material, the transfer foil is fed through a transfer nip together with the printing material. The transfer nip is formed by a transfer cylinder and an impression cylinder that are in engagement with each other. The transfer cylinder and the impression cylinder rotate and are engaged with each other at a contact pressure that is suitable to ensure that the transfer layer is transferred to the printing material in the transfer nip.

In order to be able to transfer the transfer layer to the desired regions on the printing material, prior to the transfer of the foil, a layer of glue is applied to the printing material in the regions that are to receive the foil.

The glue may be colorless or it may have a specific color of its own or a color that corresponds to that of the foil. In the field of bronzing technology, it has become known to use a particularly sticky ink to transfer metal particles. The color of the ink corresponds to the color of the desired metalizing. Thus, a sticky ink may of course be used as an alternative to the colored glue.

The transfer layer may basically be a metal layer or any other type of layer. For instance, it may be an aluminum layer that is applied to a yellow/golden or silver layer of varnish.

Alternatively, the transfer layer may be a colorless layer made of a PE foil that is transferred to the printing material to form a protective coating.

The use of a conductive layer as the transfer layer is likewise conceivable in order to transfer electrically and/or thermally conductive areas to the printing material. Even the transfer of prepared clearly defined layer areas as the transfer layer is possible. Those may, for instance, be RFID chips or their antennae. Suitable ceramics may likewise be transferred. In that manner it is even possible to transfer superconductive structures to a printing material.

A device of that general type for cold-foil stamping is known from European Patent EP 0 578 706 B1, corresponding to U.S. Pat. Nos. 5,565,054 and 5,735,994.

In accordance with that document, the cold-foil stamping process is carried out in a multicolor printing press. The printing material, which may be sheets of paper or cardboard or a web of material, is conveyed along a predetermined conveying path in the printing press.

In a first printing unit of the printing press, glue is transferred to the printing material instead of ink. A printing plate carrying a corresponding image is provided in that printing unit to apply glue to the printing material in a manner similar to a conventional offset printing ink.

Then, the printing material is conveyed to a second printing unit in which the impression cylinder and the blanket cylinder are embodied as a transfer unit.

In the region of that second printing unit there is a foil module including a transfer foil supply reel and a transfer foil collecting reel. Intermediate rollers of a foil guiding device guide the foil from the transfer foil supply reel to the transfer nip and further on to the transfer foil collecting reel.

In order to transfer the transfer layer to the printing material, the transfer foil and the printing material, including the regions to which glue has been applied, are passed through the transfer nip together with the transfer layer, which rests on the glue layer. Pressure is applied in the transfer nip to transfer the transfer layer to the printing material. The transfer layer is cleanly taken off the transfer foil due to the glue.

In order to ensure a clean transfer of the transfer layer to the printing material, the foil and the printing material are driven at the same speed in the region of the transfer nip during the transfer.

In the device presented therein, the foil module is associated with the printing unit in which the foil is to be transferred.

If, for instance, in a first print job, layers of ink are to be applied to the printing material in the first printing units, followed by a protective coating or a metal coating from a transfer foil, the printing unit that applies the glue and the following printing unit, which is embodied as the transfer unit, is located downstream of the printing units that apply ink.

If, however, in a second print job, a layer of metal is to be transferred to the printing material prior to the application of ink, the entire foil module including the supply reel, the collecting reel, and the foil guiding elements needs to be removed from the printing unit and mounted to another printing unit upstream of the other printing units. At least one other printing unit for applying glue needs to be provided upstream of the printing unit associated with the foil module. A flexible set-up of the device to enable a foil transfer at different locations is not possible with the known device.

A more flexible set-up of the transfer device described above is disclosed in European Published Patent Application EP 1 829 685 A2, corresponding to U.S. Pat. No. 7,793,697. A higher degree of flexibility is attained by providing guide elements for guiding a transfer foil from a stationary foil supply reel to the respective desired transfer nip and a stationary collecting reel, at least in the region of all potential transfer nips formed, for instance, by the blanket cylinder and the impression cylinder of a sheet-fed printing press. Due to a particularly convenient configuration of the guiding elements for guiding the transfer foil, the supply reel and/or the collecting reel need not be moved to different printing units. Instead, additional guide elements for guiding the transfer foil itself are provided everywhere in the region of the printing press itself or above the printing press and/or in the region of further printing presses.

Due to the flexible path of the web of foil proposed in the document mentioned above, the path of the foil may be very long. That is disadvantageous in terms of the set-up of the transfer device if the transfer foil is to be fed to new transfer nips. In addition, long stretches of foil path may result in undesirable vibrations or tension changes in the transfer foil. Those phenomena may have a detrimental effect on the quality of the printed product itself or may even cause the web of foil to tear.

### SUMMARY OF THE INVENTION

It is accordingly an object of the invention to provide a foil transfer device having a variable guide system, which overcomes the hereinafore-mentioned disadvantages and solves the above-described problems of the heretofore-known devices of this general type or at least reduces difficulties that may arise.

With the foregoing and other objects in view there is provided, in accordance with the invention, a transfer device for transferring a transfer layer from a transfer foil to a printing material. The transfer device comprises an application unit for applying a layer of glue to areas of the printing material. At least one basic module is substantially formed by a processing unit such as a printing unit, a varnishing unit, an embossing unit, a creasing unit or the like of a sheet or web material processing machine. The at least one basic module includes a transfer cylinder and an impression cylinder forming a transfer nip therebetween. A transfer module is structurally separated from the at least one basic module and has at least one foil supply reel and/or foil collecting reel, a transfer foil provided by the at least one foil supply reel and guide elements and/or timing elements for guiding and/or timing the transfer foil. The transfer foil is guided through the transfer nip together with the printing material for transferring the transfer layer to the printing material in the areas of the printing material to which glue has been applied. A guide system guides the transfer module to different basic modules of the same and/or further sheet or web material processing machines.

Due to the structural separation of the transfer module itself from the basic module, the transfer module can easily be repositioned in a different processing unit of a machine for processing sheets if a guide system for guiding the transfer module to different basic modules of the same and/or at least one further machine for processing sheets or webs of material is provided. In this context, the basic module is embodied as a conventional processing unit, preferably a printing unit, in a machine for processing sheets or webs of material. In accordance with a particularly preferred embodiment, the machine is a machine for processing sheets, in particular a sheet-fed lithographic offset printing press. The processing unit may preferably be a printing unit or a varnishing unit, but may likewise be embodied as an embossing unit, a creasing unit, or a similar unit. The transfer module includes at least the foil supply reel and/or the foil collecting reel. In a particularly preferred embodiment, the transfer module includes both the foil supply reel and the foil collecting reel. In addition, guide elements for guiding the foil to the basic module may advantageously be provided. There may also be additional timing elements for implementing a foil-saving mode of the foil feed. Both the guide elements and potential timing elements may then be moved directly to further basic modules of the printing press together with the transfer module by the guide system. At their new location, these elements may then be used without elongating the conveying path of the web of foil. The use of a guide system dispenses with the need to dismount the transfer module from the basic module inasmuch as it can simply be moved to the next desired basic module on the guide system.

In accordance with another particularly advantageous feature of the invention, the transfer module may include at least one guide element for guiding the transfer module in and/or on and/or below the guide system.

In accordance with a further development of the invention, the transfer module includes a trunk region having at least a foil collecting and/or a foil supply reel as well as a guide frame for connecting the trunk region to the at least one guide element.

The guide element may be rollers engaging in the guide system. Within the guide system, such guide elements may be connected above or below the guide system to ensure that the transfer module is guided by the guide system.

In accordance with an added advantageous feature of the invention, the guide system may be a system of tracks provided below the machine for processing sheets or webs of material, for instance on the floor of a pressroom. Alternatively, this system of tracks may advantageously be provided above this machine and may be connected to the ceiling or disposed on the ceiling. The track system may likewise be provided directly on the machine. It may, for instance, be provided in the marginal region of the basic modules, i.e. in the marginal region of the printing units or other further processing units of the printing press. In this case, the guide or track system may be easily set up during a reconfiguration of the machine itself.

In accordance with an additional feature of the invention, alternatively, a gallery may be provided in the region of the basic module or in the region of all basic modules of a machine for processing sheets or webs of material. This gallery may, for instance, be provided for a machine operator to stand on when accessing the machine. In accordance with the invention, the gallery may be firmly connected to the transfer module. In particular, the connection may be implemented through the guide frame. The entire gallery may then be guidable together with the transfer module in the guide system itself and may thus be jointly moved.

In accordance with yet another feature of the invention, however, the gallery itself may have a modular structure, with individual gallery modules being associated with respective individual basic modules. Especially the gallery module associated with the basic module including the transfer module is to include recesses suitable for connecting the guide elements of the transfer module to the guide system. The modules of the gallery are to be individually removable to ensure that the region for guiding the transfer module is exchangeable with another region. Thus, the modules can be removed, the transfer module can be guided to a further basic module in the guide system, and finally the gallery modules can be exchanged so that that module which has an area with recesses for the guide elements is now disposed in the region of the new basic module.

In accordance with yet a further feature of the invention, moreover, the gallery may be at least partly foldable or pivotable. Thus, the guiding of the transfer module can be implemented by providing opened or deviated gallery modules or the gallery itself for cooperating with the guide system. Advantageously, only that region of the gallery in which the guide elements are engaged in the guide system to guide the transfer module may be unfolded or pivoted. In the configurations that feature the gallery described herein, the guide system itself, in particular, is disposed below the gallery and may be formed of tracks, for instance.

In accordance with yet an added development of the invention, a locking element may be provided on the transfer module and/or on the basic modules and/or on the guide system for locking and positioning the transfer module relative to the basic module. Thus, the transfer module may be guided to the desired basic module through the use of the guide system and may then be locked in position through the use of the locking element to prevent any position change relative to the basic module and thus relative to the transfer nip, thus eliminating a potential risk of tearing the web.

In accordance with yet an additional feature of the invention, in order to facilitate the guiding and conveying of the transfer modules to further basic modules, a drive is provided at least to assist in moving the transfer module relative to a basic module.

In accordance with again another feature of the invention, in order to prevent accidents involving persons or objects and the transfer module, at least one safety element and/or a detection device for detecting people in the region of the guide system and/or for detecting the condition of the transfer foil relative to the basic module is provided. In particular, the safety element may be used to detect people that may be present in the region of the guide system. If there are any, the transfer module may be prevented from moving. The detection device of the invention may detect the condition of the transfer foil and prevent the transfer module from being moved if the transfer foil is still threaded through the basic module, i.e. fed to guide elements and/or to the transfer nip therein. Thus, accidents involving persons or objects the transfer module might hit while being moved can be avoided. At the same time or alternatively, the web of transfer foil is prevented from tearing and damage to the basic module due to an unforeseen movement of the transfer module is avoided.

In accordance with a concomitant embodiment of the invention, a position detection device is provided at least in the region of one of the basic modules to detect a transfer module in the vicinity of the basic module. Such a position detection device may actuate a feed-in device for feeding the foil into the basic module, or a control unit of the machine for processing sheets or webs of material may be set up to be alerted to the presence of such a transfer module. It is likewise possible to actuate a control unit and/or the locking device.

Other features which are considered as characteristic for the invention are set forth in the appended claims.

Although the invention is illustrated and described herein as embodied in a foil transfer device having a variable guide system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, top-plan view of a foil transfer device having a displaceable transfer module;

FIGS. 2A and 2B are longitudinal-sectional views of a foil transfer device including alternative guide systems; and

FIG. 3 is a cross-sectional view of a transfer unit taken along a line III-III of FIG. 1 in the direction of the arrows.

### DETAILED DESCRIPTION OF THE INVENTION

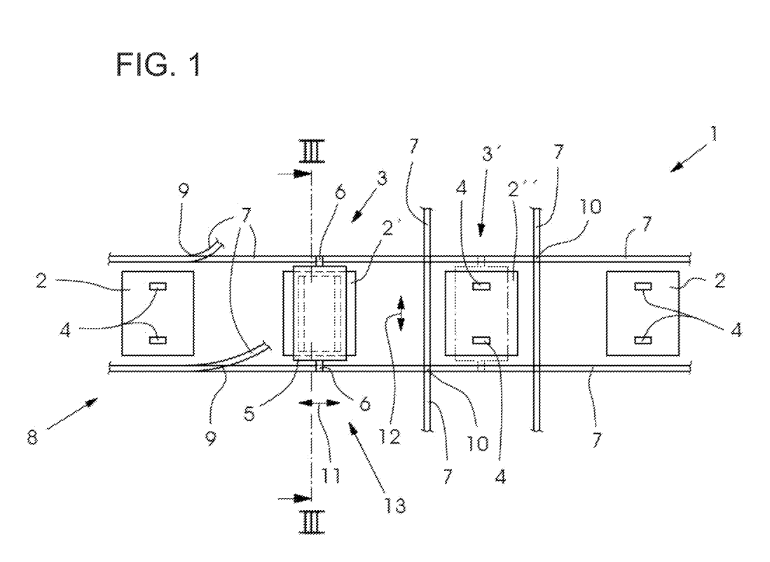

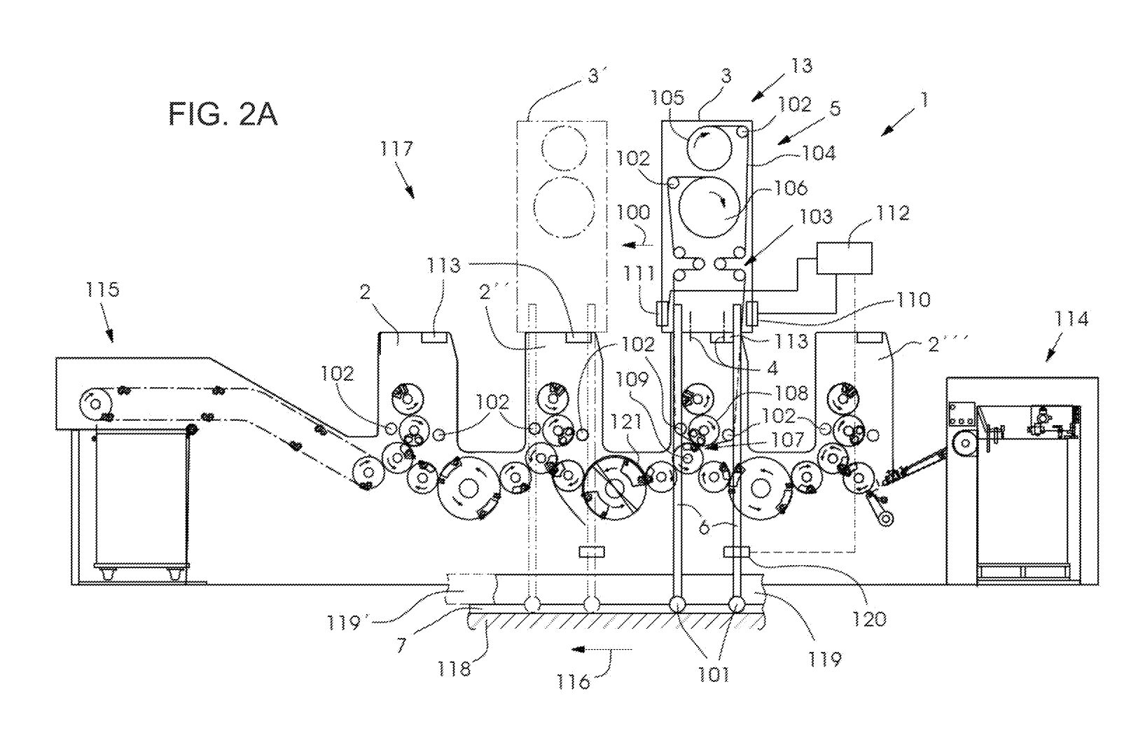

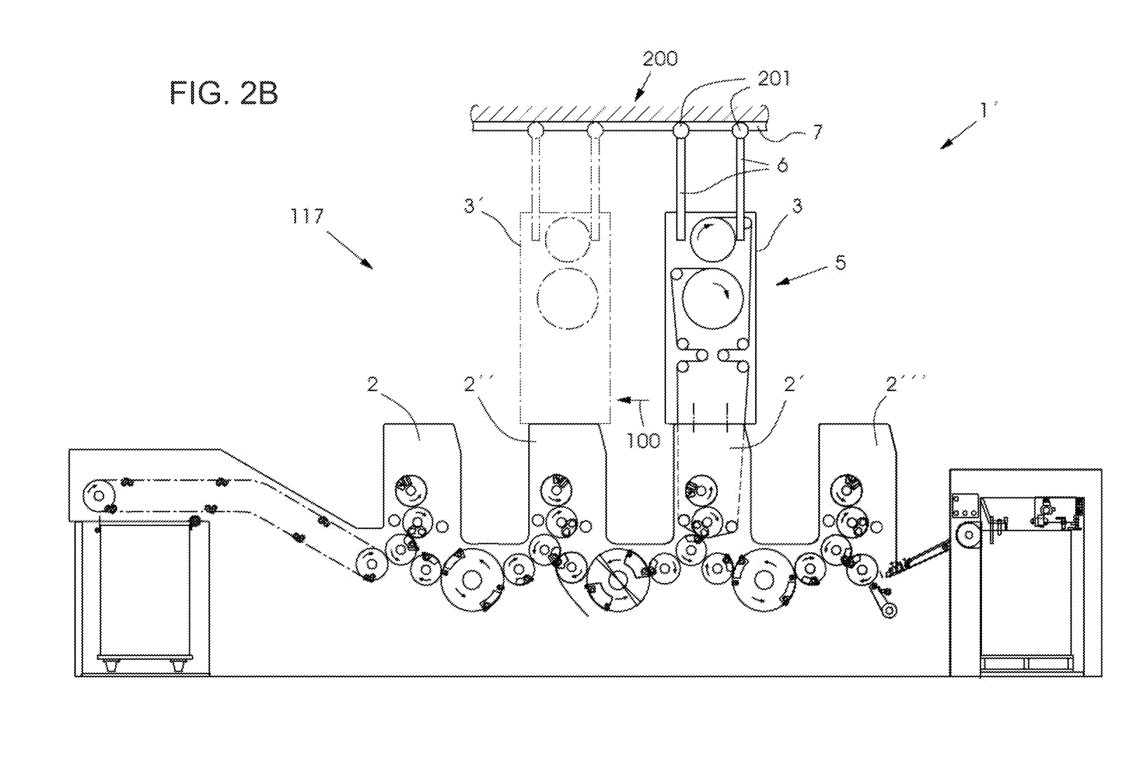

Referring now to the figures of the drawings in detail and first, particularly, to FIG. 1 thereof, there is seen a diagrammatic illustration of a foil transfer device 1 which may be part of a printing press 117 shown in FIG. 2A. A region illustrated in the figure includes four basic modules 2, 2′ and 2″. The basic modules 2, 2′, 2″ are printing units of the printing press 117. A transfer module 3, which will be described in greater detail below with reference to FIG. 2A, is provided on the basic module 2′. The transfer module 3 is firmly but releasably connected to the basic module through the use of locking elements 4 that are provided on each basic module 2, 2′, 2″ and may require counterparts in the transfer module 3.

The transfer module 3 is formed of a trunk region 5 which, in particular, includes a transfer foil supply reel 105, a foil collecting reel 106 and a guide frame 6. The guide frame 6 is fixed to the side of the trunk region 5 and connects the trunk region 5 to a guide system 8. The guide system 8 is formed of tracks 7 provided laterally below or above the printing press 117 or foil transfer device 1. For guiding purposes, the guide frame 6 includes further guide elements in the form of rollers 101, 201, which may engage in the tracks 7 to guide the transfer module 3 within the guide system 8. Thus, at least in the region of a foil transfer device 1, the transfer module 3 is displaceable in a guided way in the direction of a double-headed arrow 11 along the extension of the foil transfer device 1. The transfer module 3 may thus be moved, for instance, from a first basic module 2′ along the tracks 7 in a direction of the double-headed arrow 11 towards a second basic module 2″. In order to be able to displace the transfer module 3 in that way into a position above the second basic module 2″, the locking elements 4 need to be released. This second possible position of the transfer module 3 above the second basic module 2″ is indicated by a transfer module 3′ represented in dashed lines. For reasons of clarity, the locking elements 4 in the region of the first basic module 2′ are not shown to be able to basically focus on the transfer module 3.

In accordance with a further embodiment of the invention, the transfer module 3 may be applied to further printing presses 117 or other machines for processing sheets or webs of material. For this purpose, the guide system 8 may be constructed to lead laterally away from the foil transfer device 1. Of course, the tracks 7 may likewise extend beyond the length of the foil transfer device 1. At the beginning, the tracks 7 extend along the foil transfer device 1. In a first possible embodiment, the tracks include switches 9 that may be operated from a control panel 112 as shown in FIG. 2A. Depending on the position of the switches 9, the transfer module 3 either moves exclusively along the foil transfer device 1 or it is guided laterally away from the foil transfer device 1 following the tracks 7 which are opened up by the switch 9. Thus, the foil transfer module is moved to non-illustrated further devices that include basic modules 2, 2′, 2″, 2′″ constructed to be able to receive the transfer module 3. Alternatively, intersections 10 may be provided instead of the switches 9. These would, however, require the rollers 101, 201 of the guide frame 5 of the transfer module 3 to be constructed to enable a movement of the foil transfer module 3 at least in the direction of the double-headed arrow 11 and in the direction of a double-headed arrow 12, which is perpendicular to the former.

FIG. 2A illustrates a lateral view of a printing press 117 structured as a foil transfer device 1. The printing units of the printing press 117 are represented as basic modules 2, 2′, 2″, 2′″. In the illustrated case, the transfer module 3 is initially disposed on the basic module 2′. The trunk region 5 is supported on the tracks 7 through the use of the guide frames 6 and the rollers 101. The transfer module 3 may then be displaced, for instance from the basic module 2′ to the basic module 2″ in the direction of an arrow 100. This second position is indicated by representing the transfer module 3′ in dashed lines. Further possible positions of the transfer module 3 are located on the other basic modules 2 and 2″.

In the illustrated case, the basic module 2′″, which is provided immediately upstream of a transfer unit 13 that includes the transfer module 3 and the basic module 2′, is embodied as an application unit. For this purpose, the basic module 2′″ is a conventional varnishing or printing unit that applies sticky ink or glue instead of a varnish or ink to printing material 121. The application of glue may be dependent on the subject. Subsequently, the printing material 121 is guided through a transfer nip 107 of the transfer unit 13. The transfer unit 13 includes a transfer foil 104 that is provided by the foil supply reel 105. Guide elements in the form of deflection rollers 102 and a system of dancer rollers 103, which ensures that the web remains under tension or provides a foil-saving mode, guide the transfer foil 104 to the transfer nip 107. The transfer nip 107 is formed by a blanket cylinder 108 and an impression cylinder 109 of the basic module 2′. As the printing material 121 is guided through the transfer nip 107 together with the transfer foil 104, the transfer layer of the transfer foil 104 is transferred to the printing material 121 in the regions to which sticky ink or glue has been applied.

As is shown in the figure, the trunk region 5 of the transfer module 3 includes at least the foil supply reel 105, the foil collecting reel 106, further deflection rollers 102 and the system of dancer rollers 103, if the latter is provided. The trunk region 5 is firmly but releasably connected to the basic module 2′ through the use of the locking elements 4. These locking elements 4 may be journals and holes and threaded portions formed on the transfer module 3 and on the basic module 2′. Alternatively, the locking elements 4 may be provided in the region of the guide frame 6 of the transfer module 3. In the illustrated embodiment, the transfer module 3 additionally includes a detection device 110 disposed in the region of the web-guiding system for guiding the transfer foil. The detection device 110 detects the condition of the web of transfer foil 104 and sends a corresponding signal to the control panel 112. This is a highly accurate way of determining or detecting whether or not the transfer foil 104 is guided in such a way as to enter the basic module 2′ and pass through the transfer nip 107. If this is the case, a prevention device in the control panel 112 may prevent the transfer module 3 from being displaced on the tracks 7.

In addition, the illustrated transfer module 3 includes a safety element 111 disposed in at least one marginal region of the trunk region 5. In particular, further safety elements 111 may be provided in front and rear regions of the transfer module 3 and in the region of the guide frame 6. This safety element 111 may, for instance, rely on acoustic interaction or optical interaction and may include ultrasound or laser sensors or video cameras or LCD or CCD sensors to detect people or objects that are present in the vicinity of the transfer module to be displaced and may thus obstruct the displacement path of the transfer module 3 in the region of the tracks 7. If the safety element 111 detects persons or objects, the control panel 112, which is connected to the safety element 111, may prevent the transfer module 3 from being displaced.

Moreover, position detection devices 113 may be provided in the region of the individual basic modules 2, 2′, 2″, 2′″. These position detection devices 113 may be connected to the control panel and may send a signal to the latter to indicate which basic module 2, 2′, 2″, 2′″ currently includes a transfer module 3.

In the illustrated embodiment of the foil transfer device 1 formed by the printing press 117, the printing material 121 is conveyed in a direction of sheet travel 116 from a feeder 114 through the basic modules 2, 2′, 2″, 2′″, which are constructed as printing units. As described above, the printing material 121 is conveyed through the application unit 2′″, where it receives a layer of glue. Subsequently, the printing material 121 passes through the transfer unit 13, where it receives the transfer layer of the transfer foil 104. In following printing units 2′, 2, further layers of ink may be transferred to the printing material 121. Layers of varnish may be applied in subsequent varnishing units. Although not shown, UV driers may be provided in the region between the individual basic modules 2, 2′, 2″, 2′″. Alternatively, a drying section may be provided downstream of the last basic module 2. Once the printing material 121 has passed through all of the basic modules 2, 2′, 2″, 2′″, it is transferred to a delivery 115.

In FIG. 2A, the guide system 8, i.e. the tracks 7, is disposed in the region of a floor 118 of a pressroom. The tracks 7 are disposed at the sides of the printing press 117.

Furthermore, a gallery 119 may be provided above the tracks 7 in the region of the floor 118. A machine operator may step onto this gallery to be in an elevated position relative to the foil transfer device 1 or printing press 117. In the illustrated embodiment, the gallery 119 is firmly connected to the guide frame 6. Thus, like the transfer module 3, the gallery 119 can be displaced in its entirety in the direction of the arrow 100. The gallery 119 is then moved in the direction of dotted lines 119′. The gallery may, in particular, include several removable regions to compensate for a longitudinal displacement in one direction by a shortening of the gallery 119 in this direction and for a shortening of the gallery 119 in the opposite direction by the insertion of the gallery region that has been removed.

Furthermore, a drive such as a motor 120 may be provided. This motor is connected to the rollers 101 in such a way that it drives the rollers 101 and may thus assist in the displacement of the transfer module 3 to the further position 3′ or may drive the displacement autonomously. For this purpose, the motor 120 is, in particular, connected to the control panel 112, which controls the motor 120 as required for a displacement of the transfer module 3, taking into account the signals of the detection device 110, the safety element 111 and the position detection device 113.

FIG. 2B illustrates an alternative embodiment in which the tracks 7 are provided in the region of a ceiling 200 of a pressroom. The tracks 7 are disposed next to the printing press 117. If the tracks 7 are disposed above the printing press 117, they may be disposed directly above the printing press 117 instead of next to and to the sides of the printing press 117. In every other respect, the structure of the foil transfer device 1′ illustrated in FIG. 2B is identical to the structure of the foil transfer device 1 shown in FIG. 2A. Identical elements have identical reference numerals. Reference numerals of elements that are not important to this representation are not shown.

In this embodiment, although the tracks are provided above the transfer module 3, the guide frame 6 is likewise connected to the tracks by the rollers 201. In contrast to the embodiment of FIG. 2A, the rollers 201 need to be constructed to engage in the tracks 7 in such a way that they cannot easily be taken out. Thus, a certain form-locking connection between the tracks 7 and the rollers 201 is desirable and the tracks preferably surround the rollers in an angular range of more than 180°. A form-locking connection is one which connects two elements together due to the shape of the elements themselves, as opposed to a force-locking connection, which locks the elements together by force external to the elements.

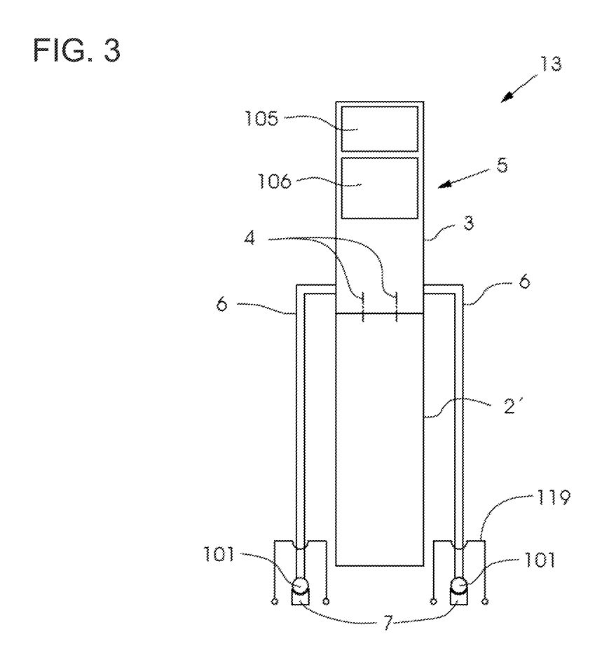

FIG. 3 is a sectional front view of the transfer unit, which is taken along the line III-III of FIG. 1.

As described above, the trunk region 5 includes the foil collecting reel 105 and the foil supply reel 106 and is connected to the basic module 2′ through the use of the locking elements 4. The locking elements 4 may be a screw connection, with a corresponding threaded portion provided on the basic module. The trunk region 5 includes holes to receive screws as the locking elements 4, which are inserted into the threaded portion of the basic module 2′ through holes to form a firm but releasable connection between the basic module 2′ and the trunk region 5.

The transfer module 3 is formed of the trunk region 5 and the guide frame 6. The guide frame 6 is shown to project from the trunk region 5 at a 90° angle and then to form another 90° angle to connect the trunk region 5 to the tracks 7 of the guide system 8. The guide frame 6 is connected to the tracks 7 through the use of the rollers 101. The right angles formed by the frame are only one example of a possible way to connect the trunk region 5 to the tracks 7. Even widely differing devices are conceivable and may even be easier to implement. In particular, the guide frame 6 may be formed by a straight frame tube connecting the trunk region 5 to the tracks 7.

As can be seen, the transfer module 3 can easily be displaced on the tracks 7 due to the rollers 101, as long as there is no firm but releasable connection to the basic module 2 provided by the locking elements 4.

Through the use of the device illustrated in the figures, it is possible to move a transfer module 3 from a first basic module 2′ to a second basic module 2″ in the longitudinal or perpendicular direction of a foil transfer device 1, as indicated by the arrow 100, in order to use the transfer module 3 for a further application of the transfer foil 104 at a different location if the control panel 112 does not act to prevent such a movement. For this purpose, all of the basic modules 2, 2′, 2″, 2′″ advantageously include deflection rollers 102 suitable for guiding the web of transfer foil 104 to the corresponding transfer nip 107 in each of the basic modules 2, 2′, 2″, 2′″.

Consequently, the transfer module 3 can be used more reliably and more flexibly within one foil transfer device 1 or even for several foil transfer devices 1 present in a pressroom.

1. A transfer device for transferring a transfer layer from a transfer foil to a printing material, the transfer device comprising:
an application unit for applying a layer of glue to areas of the printing material;
at least one basic module substantially formed by a processing unit selected from the group including a printing unit, a varnishing unit, an embossing unit and a creasing unit of a sheet or web material processing machine, said at least one basic module including a transfer cylinder and an impression cylinder forming a transfer nip therebetween;
a transfer module structurally separated from said at least one basic module, said transfer module having at least one of a foil supply reel or foil collecting reel for the transfer foil, and at least one of guide elements or timing elements for at least one of guiding or timing the transfer foil, the transfer foil being guided through said transfer nip together with the printing material for transferring the transfer layer to the printing material in the areas of the printing material to which glue has been applied; and
a guide system for guiding the transfer module to different basic modules of at least one of the same or further sheet or web material processing machines.

2. The transfer device according to claim 1, wherein said transfer module includes at least one further guide element for guiding said transfer module at least one of in, on or below said guide system.

3. The transfer device according to claim 2, wherein said transfer module includes a trunk region having said at least one foil supply reel or foil collecting reel and a guide frame for connecting said trunk region to said at least one further guide element.

4. The device according to claim 1, wherein said guide system is a system of tracks provided at least one of above or below said sheet or web material processing machine.

5. The device according to claim 1, wherein said guide system is a system of tracks provided in a marginal region on said sheet or web material processing machine.

6. The transfer device according to claim 1, which further comprises a gallery disposed in vicinity of said at least one basic module and permitting an operator to stand on said gallery, said gallery being firmly connected to said transfer module and configured to be guided together with said transfer module in said guide system.

7. The transfer device according to claim 2, which further comprises a gallery disposed in vicinity of said at least one basic module and permitting an operator to stand on said gallery, said gallery having a modular construction including a region with recesses for said further guide elements to form a connection to said guide system, said region being removable for guiding said transfer module and exchangeable with another region.

8. The transfer device according to claim 2, which further comprises a gallery disposed in vicinity of said at least one basic module and permitting an operator to stand on said gallery, said gallery being at least partially foldable or pivotable to release a connection between said further guide elements and said guide system for guiding said transfer module.

9. The transfer device according to claim 1, which further comprises a locking element disposed on at least one of said transfer module or said at least one basic module or said guide system for positioning and locking said transfer module relative to said at least one basic module.

10. The transfer device according to claim 1, which further comprises a drive device for at least assisting in a displacement of said transfer module relative to said at least one basic module.

11. The transfer device according to claim 1, which further comprises at least one of a safety element or a condition detection device for at least one of detecting people in vicinity of said guide system or detecting a condition of the transfer foil relative to said at least one basic module.

12. The transfer device according to claim 1, which further comprises a position detection device disposed at least in vicinity of one said at least one basic module for detecting said transfer module in vicinity of said at least one basic module.
